(19) United States
(12) Patent Application Publication
(10) Pub. No.: US 2011/0079161 A1
(43) Pub. Date: Apr. 7, 2011

(54) PLATE MONITORING SYSTEM

(76) Inventors: Shay Amsili, Kfar Yona (IL); Yehuda Solomon, Rishon Le Zion (IL); Yoav Telem, Kfar-Schmaryahu (IL)

(21) Appl. No.: 12/574,722

(22) Filed: Oct. 7, 2009

(51) Int. Cl. B41F 33/00

(52) U.S. Cl. 101/483; 101/395

(57) ABSTRACT

A system for processing printing plates (100) includes plurality of printing plate processing stations (108, 116, 120, 124) arranged in a serial chain configuration. The first station in the chain configuration is adapted to receive printing plates (132), apply station specific treatment to the printing plates and convey (112) the printing plates after the specific treatment is performed to the next station in the chain configuration. A system controller (104) adapted to monitor and control each of the plate processing stations.

### FIELD OF THE INVENTION

The present invention relates to monitoring and control of imaging of printing plates.

### BACKGROUND OF THE INVENTION

A prepress production system usually includes a series of units, wherein each unit serves a different function in the production line. A typical configuration will include an imaging device, which receives a blank plate, images it, and hands it over to the next unit. The following units may include a plate processor, oven post bake device, gumming device, a stacker, a bender, or other. The plate is transported either manually between the various units or automatically via a dedicated conveyor linking between two adjacent units. FIG. 1 illustrates series of plate production units linked together, forming a pipelined configuration.

A typical line will utilize several units having different functions. Those different apparatuses are usually manufactured by plurality of vendors, and seldom communicate with each other. On-line monitoring of the plate status in the prepress production line is a critical element in achieving sufficient production efficiency. The ability to monitor and report plate condition in each stage in the production line is necessary to save time and reduce consumables waste.

Most of the units in the prepress production line lack, or possess limited, external interfaces. This fact makes the interface with such units, for example plate oven or plate processor very difficult. In order to introduce plate monitoring and control capabilities, it is essential to provide connectivity between the various prepress production line devices. The invention proposes methods and system to overcome the limitation discussed above.

### SUMMARY OF THE INVENTION

Briefly, according to one aspect of the present invention a system for processing printing plates includes a plurality of printing plate processing stations arranged in a serial chain configuration. The first station in the chain configuration is adapted to receive printing plates, apply station specific treatment to the printing plates, and convey the printing plates to the next station in the chain configuration. A system controller monitors and controls each of the plate processing stations. A plate inspecting device comprises an electronic communication element and at least one inspecting element attached to each of the stations. The plate inspecting device inspects and measures the printing plates and sends the measurement status data to the controller via the communication element.

The controller is configured to receive the status data of the printing plate from each of the plate inspecting devices and to analyze the data by comparing it to anticipated status data. The controller monitors the system according to the comparison.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic illustrating plate production system using various stations, such as imaging, developing and post production;

FIG. 2 is a schematic illustrating plate inspecting device; and

FIG. 3 is a schematic illustrating plate production system controlled by client-server configuration.

### DETAILED DESCRIPTION OF THE INVENTION

It is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Printing plates are imaged by using optho-mechanical plate imaging systems such as by the Magnus family of plate imaging device, made by Eastman Kodak Company. The imaged plate is further processed by post imaging devices such as plate developer (plate processor), plate oven treatment, or other relevant processes, which are essential to fix the plate for mounting on a printing press. For clarity purposes, the term plate preparation station (or station) is used in this document to describe the various steps for printing plate preparation, some of which are mentioned above.

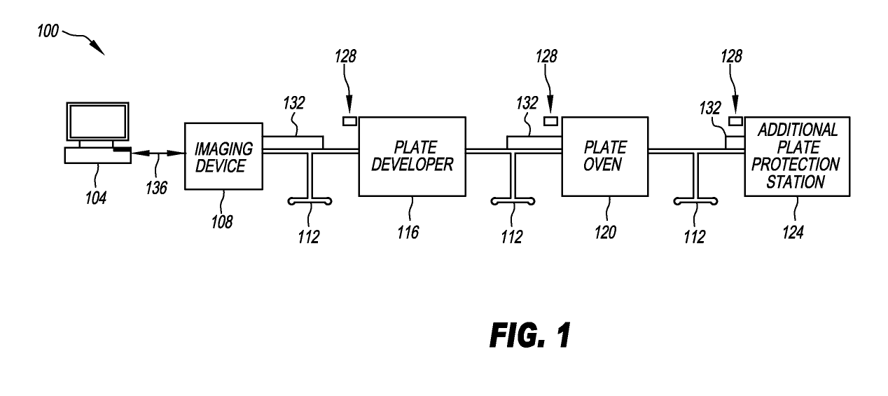

The linkage between the stations in the plate preparation sequence is done, either manually by moving the plate between stations or by utilizing automatic conveyors to move the plate from one station to the next one. For example, when a plate is imaged, it is taken off the imaging device and loaded into a plate developing station and so on, manually or via an in-line plate conveyor 112 as is depicted in FIG. 1.

A plate preparation system 100 is shown in FIG. 1. The printing plate 132 is moved from one station to the next, by automatic plate conveyors 112. The plate conveyors 112 are adapted to move the plate from one station and load the plate into the next station in the sequence for further processing. The stations used during plate preparation may have been manufactured by a variety of vendors, and often are of different technological generations. This makes automatic coordination between the stations cumbersome. The stations are often not equipped with external communication or command and control means, which makes the task of plate preparation status gathering difficult.

The present invention describes methods and apparatus for providing efficient status and control means during plate preparation. Referring to FIG. 1, plate preparation system controller 104 gathers the status information pertaining to plate preparation process throughout the entire plate preparation workflow.

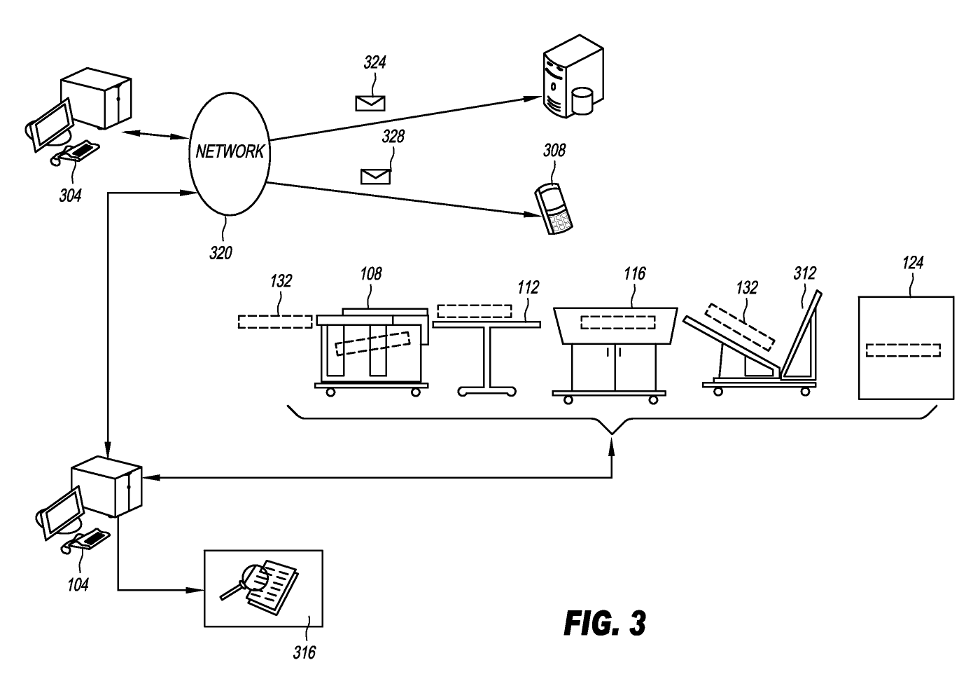

FIG. 3 shows a plate preparation system 100 operated via a computer client application 304, the client application can be executed on controller 104 or on a different computer that is configured to communicate with controller 104. The client application 304 communicates with controller 104 through the network 320. Controller 104 controls and monitors an imaging device 108 via control lines 136. The configuration on client-server architecture enables controller 104 operator to monitor and control the plate preparation system 100 through client application 304 whether in proximity to controller 104, or alternatively from a remote site, such as from home, over a digital network 320. Controller 104 can monitor and control more than a single plate production system 100 in parallel. The various preparation systems 100 may reside in different geographical location.

The imaging device 108 images printing plate 132. At imaging completion, a printing plate 132 is ejected from imaging device 108 onto a plate conveyor 112, and automatically loaded inline into the plate developer 116. Plate inspecting device 128 inspects the movement of plate 132 into plate developer 116.

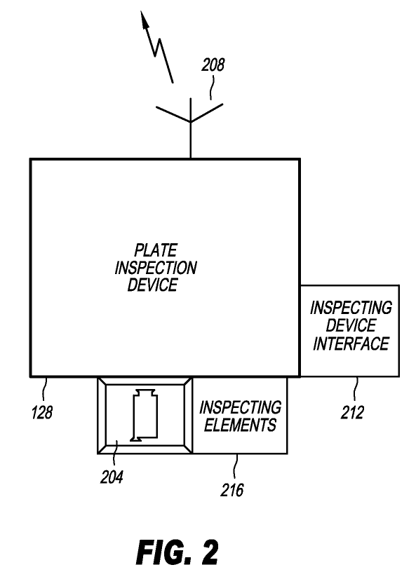

FIG. 2 depicts a more elaborate structure for plate inspecting device 128. Plate inspecting device 128 may include at least one or more of the following inspecting elements 216 in addition to camera 204: pH sensor, humidity sensor, temperature sensor, plate movement sensor, plate sensitivity detector.

Camera 204, or alternative detecting system, will inspect the movement of printing plate 132, and reports the status of printing plate 132 to controller 104 via communication link 208. The communication link 208 may be wireless communication. This process will be repeated between all other stations at which printing plate 132 should be treated during plate the plate production stage, such as plate movement between plate developer 116 via plate conveyor 112 into plate oven 120, and between plate oven 120 into an additional plate production station 124 via plate conveyor 112, or any other plate processing device configured in the plate processing workflow, such as gumming device, pre-bake or post-baked stacker 312 (shown in FIG. 3).

The status information pertaining to plate progress within the plate production system, or the plate condition will be sensed and reported back to controller 104 and the status will be displayed to the user. The monitoring of printing plate 132 is achieved by few different methods. The plate movement pace is measured and calibrated for each device in the plate preparation workflow, the calibration take into account the size of the plate to be treated. The above measurements are configured into controller 104. The controller anticipates the processing time required to process printing plate 132 for each processing station according to the acquired measurements. The plate inspecting devices 128 will report the status of printing plate 132 to the controller 104. In the cases where printing plate 132 was anticipated to complete processing in one of the stations, and plate inspecting device 128 was not able to locate the plate in the anticipated position, controller 104 will warn the user on an abnormal situation.

In another embodiment each plate is equipped with a unique barcode or with an RFID unique identifier. Those embodiments requires equipping device 128 with barcode and/or RFID readers.

Device 128 can be interfaced via inspecting device interface 212 to plate processing stations equipped with electronic interfaces. As discussed in the background section, many of the devices used during plate preparation such as plate developer 116, plate oven 120, or additional plate preparation lack, or possess limited external interfaces for digital status reporting purposes. The proposed invention suggests upgrading these legacy type of devices and equipping them with inspecting and status reporting means.

The plate inspecting device 128 or alternative plate inspecting elements 216 can operate independently both in inspecting and collecting the status data of the equipment to which it is attached, as well as sending the collected information to the plate preparation system controller 104. Identical inspecting devices can be used for all the machinery configured in the plate preparation system 100 chain.

The data collection by controller 104 may help, for example, to decide on adjusting processor 116 roller speed to comply with the type and/or size of processed printing plate 132. Similarly plate oven 120 can be adjusted for electricity usage optimization. Specific alerts can be prepared and sent by controller 104 by generating electronic mail messages 324, or short message service (SMS) messages 328 into cellular phone 308.

Additional data may be collected such as plate and plate developing chemicals condition, by deploying measurement sensors such as PH level, humidity and temperature sensors, throughout plate preparation system 100 and stations. Controller 104 may change system parameters such as baking temperature or adjust replenishing plate developer 116 chemistry fluid to gain better fluid conductivity, thus improving plate development quality.

In another embodiment, fresh chemicals in plate developer 116 will yield better quality plates, than plates developed without fresh chemicals. By reading density levels of a developed plate with a densitometer sensor and sending data to controller 104, controller 104 can change the exposure parameters of the imaging device 108, thus strengthening exposure laser to overcome “weakening” of developer development chemistry.

An additional example relates to the pace of plate movement in system 100. The plate movement motor speed is known, as well as plate length, and those parameters it can be estimated by controller 104 by the time it takes a plate to move between stations in plate preparation system 100.

Status reports 316 can be generated and printed by controller 104. The reports can be for example:
1. Media-Job report—a detailed expose job description that will include date/time/name/separation/plate/operator. The report will also include a summary of plate usage per plate type/plate number and plate area.
2. Processor report—a detailed report on specific plate developer working features. This report will include developer parameters such as developer temperature, conductivity, and speed.
3. Efficiency report—a detailed report on the behavior of the prepress device. This report may include device working statistics data such as working time versus idle time.
4. Plate consumption report—a report on the prepress plate consumption in the prepress device, depending on the plate type, size.
5. Estimated ink usage at the printing stage report—this report can is compiled by an analysis of the image data to be imaged on plate, conditioned on the plate type and plate developing chemistry.

The invention has been described in detail with particular reference to certain preferred embodiments thereof, but it will be understood that variations and modifications can be effected within the scope of the invention.

### PARTS LIST

100 plate preparation system
104 plate preparation system controller
108 imaging device
112 plate conveyor
116 plate developer (plate processor)
120 plate oven
124 additional plate production station
128 plate inspecting device
132 printing plate
136 control lines
204 camera or alternative plate inspecting means
208 communication link
212 inspecting device interface
216 inspecting elements
304 client application
308 cellular phone
312 plate stacker
316 status report
320 network
324 email messages
328 SMS messages

1. A system for processing printing plates comprising:
a plurality of printing plate processing stations wherein said stations are arranged in a serial chain configuration and wherein a first station in said chain configuration is adapted to receive said printing plates, apply station specific treatment to said printing plates and convey said printing plates after said specific treatment is performed to the next station in said chain configuration;
a system controller adapted to monitor and control each of said plate processing stations;
a plate inspecting device wherein said plate inspecting device comprising an electronic communication element and at least one inspecting element wherein said plate inspecting device is attached to each of said stations and wherein said plate inspecting device is adapted to inspect and measure said printing plates and to send the measurement status data to said controller via said communication element; and
wherein said controller is configured to receive said status data of said printing plate from each of said plate inspecting devices and to analyze said status data by comparing it to anticipated status data and monitor said system for processing printing plates according to the comparison.

2. The apparatus of claim 1 wherein said plate inspecting elements comprises of at least one of camera, barcode reader, RFID reader, pH sensor, temperature sensor, humidity sensor, motion detector, densitometer, or a combination thereof.

3. The apparatus of claim 1 wherein said communication element comprising wireless communication.

4. The apparatus of claim 1 wherein said controller is operated from a remote site.
